(19) United States
(12) Patent Application Publication
(10) Pub. No.: US 2004/0184531 A1
(43) Pub. Date: Sep. 23, 2004

(54) Dual video compression method for network camera and network digital video recorder

(76) Inventors: Byeong-Jin Lim, Seoul (KR); In-Keon Lim, Seoul (KR)

Correspondence Address: VOLENTINE FRANCOS, P.L.L.C., Suite 150, 12200 Sunrise Valley Drive, Reston, VA, 20191, US

(21) Appl. No.: 10/803,908

(22) Filed: Mar. 19, 2004

(30) Foreign Application Priority Data
Mar. 20, 2003 (KR) 2003-0017420

(51) Int. Cl. H04N 7/12

(52) U.S. Cl. 375/240.01; 375/240.12

(57) ABSTRACT

A dual moving picture compression method that executes both moving picture compression for displaying a moving picture with high picture quality in real-time and moving picture compression for recording the moving picture at a high compression ratio and a low speed. A network camera and a network DVR are employed. The network camera includes two moving picture encoders that dually compress an image to transmit them to a network. The network DVR receives the dually compressed image to display the image on a monitor in real time and simultaneously records the image at a high compression ratio and a low speed. Accordingly, the requirements for teal-time moving picture display and long-term recording can be simultaneously satisfied.

### CROSS REFERENCE TO RELATED APPLICATION

This application claims priority under 35 USC § 119 to Korean Patent Application No. 2003-17420, filed on Mar. 20, 2003, the contents of which are incorporated herein by reference in their entirety.

### FIELD OF THE INVENTION

Embodiments of the present invention relate to a network camera and a network digital video recorder that compress moving picture for both high picture quality and lower picture quality at the same time. A network DVR is a digital video recorder that is used for video monitoring. The digital video recorder compresses video signals captured by a plurality of video cameras (e.g. four or sixteen channels) into digital video data and store the compressed video signals on hard disks. The digital video recorder reproduces, transmits or backs up the stored digital video data.

FIG. 1 shows the construction of a DVR system. In FIG. 1, a video signal captured by each video camera 10 is converted into an analog video signal by a video encoder. The video encoder is embedded in the video camera 10. The video signal is transmitted to the DVR 20 through the cable 15. The analog video signal inputted to the DVR 20 is converted into digital video data through a video decoder chip, compressed by a moving picture encoder, and then stored in the hard disk.

The video signal output from the video camera 10 is an analog signal and it is inputted into the DVR 20 through the coaxial cable 15. The cable 15 is connected between the video camera 10 and DVR 20. The cable 15 transfers analog signals even though the video camera 10 and the DVR 20 processes digital signals.

The cable 15 is connected between each video camera 10 and the DVR 20 in a one-to-one manner and analog signals are transmitted. Accordingly, it is relatively difficult to install the cable and installation cost is relatively high. For example, if 1600 video cameras are installed in a large building, 1600 cables would be required between each of the 1600 video cameras and the DVR 20. Further, 100 digital video recorders are needed when 1600 channels are used. That is, when a specific building or area is monitored using hundreds or thousands of video cameras, cables equal to the number of video cameras must be connected to a central control center in which a DVR is installed. Accordingly, tens or hundreds of meters may be necessary for each video camera to transmit video signals captured by the video cameras to the DVR. This large amount of cables is difficult to implement and increases installation costs in proportion to the number of cables and installation distance.

FIG. 2 shows a network camera and network DVR. Techniques associated with the network DVR are disclosed in International Patent Publication WO 2002/80033 and Korean Patent Laid-Open Publication No. 2002-0018988.

In FIG. 2, embedded in the network camera 55 is the camera module 30 and the moving picture encoder 50. The embedded moving picture encoder 50 avoids analog cables that are costly and occupy a large amount of space. The camera module 30 and moving picture encoder 50 can be integrated into the network camera 55 or part of an apparatus separate from the network camera.

If the network camera is integrated with the camera module and the moving picture encoder, the camera module is directly connected to the moving picture encoder in digital fashion. Otherwise, if the network camera is separated from the camera module, the moving picture encoder includes a video decoder chip (instead of the camera module 30) to receive analog video signals transmitted from a video camera.

The separation type network camera is generally located close to the video camera. It may be connected with the video camera through a coaxial cable as short as several meters.

A digital video signal inputted to the moving picture encoder 50 embedded in the network camera 55 is digitally compressed and outputted as bit stream data. This bit stream data is transmitted to the network DVR 60 through a network 70 (e.g. the Ethernet). Moving image data transmitted from each network camera is displayed on the monitor of the network DVR 60 in real time and simultaneously stored on a hard disk. The operator of the network DVR 60 can reproduce, transmit or back up the stored data if required.

The network cameras use the network 70 (but not analog cables) to transmit images. The network cameras can be easily connected in parallel to the network 70 (within a range that does not exceed the bandwidth of the network 70 using parallelism that is characteristic of the Ethernet). Accordingly, the number of network LAN cables 70 for connecting the network cameras to the network DVR can be minimized.

The DVR has a function of displaying a video signal inputted thereto on its monitor in real time and a function of recording the digitally compressed video data on a hard disk. During displaying of video signals, when the operator operates the DVR, he/she may want to display all of images captured by cameras on the monitor in real time (e.g. 30 frames per second in the case of NTSC and 25 frames per second in the case of PAL; explanation is made based on NTSC hereinafter).

During recording, the operator may want to record images at a speed as low as 1-8 fps (which is not the maximum speed) in order to save hard disk space. Real-time recording at the same speed as the displaying speed (e.g. 30 frames per second) requires a hard disk capacity several times larger than the capacity needed for low-speed recording. To satisfy this requirement, the DVR shown in FIG. 1 generally includes a real-time display board that displays video signals outputted from video cameras in real time all the time and a capture board for recording by which a user can record images at a desired speed within a range of less than 30 frames per second for each camera. Accordingly, the network camera and network DVR shown in FIG. 2 have technical problems due to the aforementioned requirement.

As described above, the network camera and network DVR of FIG. 2 convert a video signal captured by the camera module 30 into digital video data, compress the converted digital video data through the moving picture compressor 50, and transmit the compressed data to the network DVR 60 through the network 70. The network DVR 60 stores the compressed data on a hard disk and simultaneously decompresses the compressed data to display it on the monitor.

However, when compressing moving pictures is done at a high compression ratio (e.g. MPEG), the display speed and recording speed of the network DVR are the same. A moving picture compression technique, such as MPEG, is based on an algorithm that compresses a moving picture based on the difference between a given video frame and a previous video frame of the moving picture. This algorithm reduces the size of the compressed bit stream data.

Accordingly, after the bit stream data has been compressed at a fixed speed and picture quality the first time, it is difficult to extract the compressed data at any speed and picture quality lower than the fixed speed and picture quality, without decompressing the compressed data. For example, bit stream data cannot be extracted at a low rate corresponding to 1-29 frames per second and VHS-graded resolution from bit stream data compressed at 30 frames per second and DVD-graded resolution. Accordingly, when compressed data is transmitted from the network camera to the network DVR 60 in the system shown in FIG. 2, the operator has no choice but to record images at a speed corresponding to the real-time display speed.

A large capacity hard disk is needed for high-speed recording, which increases costs. Alternatively, if low speed recording is used (to preserve storage space of a hard disk), the real time moving picture with high picture quality and smooth motion is not possible.

When still image compression techniques (e.g. JPEG or Wavelet) are applied to moving picture compression, a moving picture is compressed at a fixed rate and picture quality. Compressed data at a rate lower than the fixed rate can be extracted, although the picture quality cannot be changed. For example, a bit stream data compressed at a rate of 30 frames per second can be the basis for a bit stream data with the same picture quality at 1-29 frames per second.

However, the picture quality cannot be changed even in this case, as the JPEG or Wavelet compression technique has a compression ratio lower than that of the MPEG compression. In other words, there is no real benefit in saving hard disk capacity.

### SUMMARY OF THE INVENTION

Embodiments of the present invention relate to a network camera and a network digital video recorder that substantially obviate one or more problems due to limitations and disadvantages of the related art.

An object of embodiments of the present invention is to display a moving image with high picture quality and smooth motion on a monitor in real time and simultaneously recording the moving image at a low speed and low picture quality. Recording at a low speed will best utilize the capacity of a hard disk, while allowing a real-time image to be viewed in a high quality format.

To accomplish objectives of embodiments of the present invention, a network camera includes a first moving picture encoder for real-time moving picture display and a second moving picture encoder for recording. The first and second moving picture encoders compress a digital image captured by the camera module at different picture qualities and rates (i.e. the number of frames per second) separately from each other. The separately compressed images are transmitted separately to a network DVR.

To accomplish objectives of embodiments of the present invention, a network digital video recorder receives data that is obtained by dually compressing an image at different picture qualities and rates from the network cameras through a network, decompresses data compressed by a first moving picture encoder to display it on a monitor in real time, and stores data compressed by a second moving picture encoder without decompressing it. The network DVR can reproduce, transmit or back up the stored data, if required.

### BRIEF DESCRIPTION OF THE DRAWINGS

FIG. 1 shows an exemplary construction of a DVR system.

FIG. 2 shows an exemplary construction of a network camera (integrated with a camera module) and network DVR system.

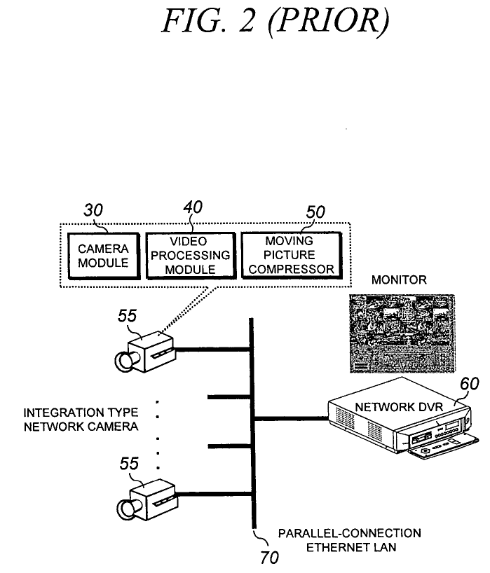

FIG. 3 shows an exemplary construction of a network camera (separated from the camera module) and network DVR system.

### DETAILED DESCRIPTION OF THE INVENTION

Reference will now be made in detail to embodiments of the present invention, examples of which are illustrated in the accompanying drawings. Embodiments of the present invention applies a moving picture compression algorithm that compresses moving pictures with a very high compression ratio (e.g. MPEG, H.263 and differential wavelet) instead of the still image compression algorithm (e.g. JPEG and wavelet) to the network camera and network DVR.

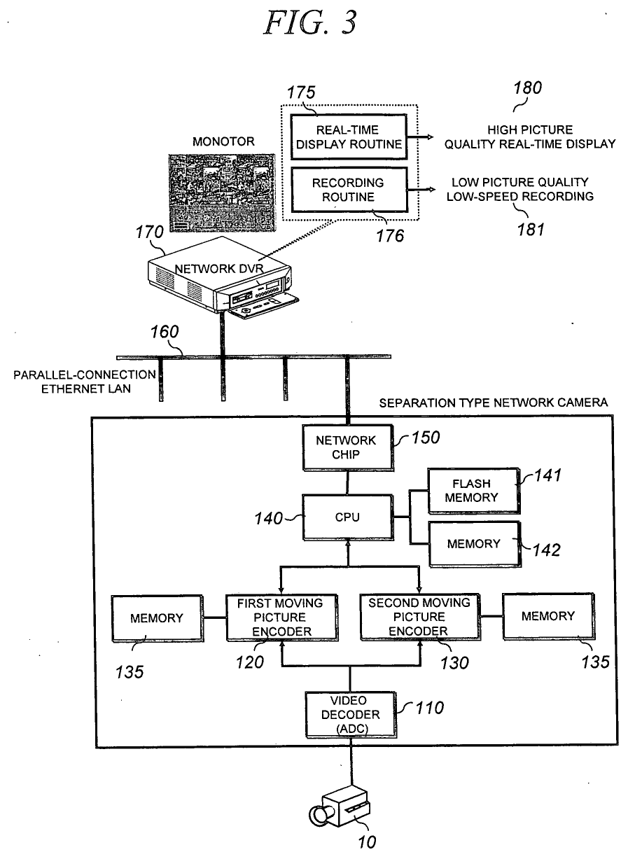

FIG. 3 shows an example of the construction of the network camera and network DVR according to embodiments of the present invention. The network camera shown in FIG. 3 is a separation type network camera, that does not include a camera module. Thus, the network camera receives analog video signals from the video camera 10. An analog video signal inputted from the video camera 10 is converted into digital video data through the video decoder 110 of the network camera. The video decoder 110 multiplexes the digital video data to the first and second moving picture encoders 120 and 130.

The first and second moving picture encoders 120 and 130 compress the received data items separately. The network camera may have two video decoders 110 to perform this function. The two video decoders would be respectively connected to the two moving picture encoders 120 and 130. The first moving picture encoder 120 is a moving picture compressor only for real-time moving picture display. To display an image with the highest picture quality and smooth motion within a bandwidth of a network, the first moving picture encoder 120 compresses the video data at a low compression ratio, which corresponds to a relatively high rate and high resolution. For example, the first moving picture encoder can compress the video data at 30 frames per second with 740×480 resolution in the case of NTSC images and at 25 frames per second with 720×576 resolution in the case of PAL images.

To represent a degree of picture quality of a compressed and decompressed image, a bit rate that is inversely proportional to the compression ratio is generally used rather than the compression ratio. In the case of a MPEG-2 algorithm, the highest picture quality is as high as DVD grade picture quality can be achieved when images are compressed at a bit rate corresponding to 4-5 Mbps through CBR (Constant Bit-Rate) control. If the network has an insufficient bandwidth, compression can be performed at a higher compression ratio (lower bit rate), lower resolution, and lower rate.

The second moving picture encoder 130 is a moving picture compressor only for recording. In general, recording is carried out at a relatively low speed and picture quality. For example, data is compressed at 4 frames per second through VBR (Variable Bit-Rate) using a MPEG-4 algorithm. Since the second moving picture encoder independently compresses the video data, it can compress the video data at the same rate and picture quality as those of the real-time display, if the operator wants and there is sufficient hard disk capacity and bandwidth.

In embodiments where two video decoders are respectively connected to the first and second moving picture encoders, the moving picture encoders can set resolutions as well as picture qualities and rates separately from each other. Two video decoders can carry out analog-digital conversion at different resolutions. However, the manufacturing cost may be higher because two video decoders are used.

A central processing unit (CPU) 140 controls the video decoder 110, the first video encoder 120, and the second video encoder 130. Software is used for the central control unit 140 to execute its control operation and may be stored in the flash memory 141. The central processing unit 140 may control a network chip 150 for an Ethernet network. A transceiver (not shown)may be used for transmitting the video data through a network 160, such as an Ethernet network. The central processing unit 140 may transmit bit stream packets, compressed through the two moving picture compressors, to a network digital video recorder 170 through Ethernet 160 with TCP/IP or UDP/IP protocol.

In embodiments of the present invention, the video camera 10, video decoder 110, first and second moving picture encoders 120 and 130, central processing unit 140, and network chip 150 can be integrated into a single network camera system or constructed separately from one another. Furthermore, the hardware circuit can be simplified in such a manner that the two moving picture encoders are integrated into the central processing unit if the central processing unit integrated with the moving picture encoders has a sufficiently high processing speed and can be directly interfaced with the video decoder.

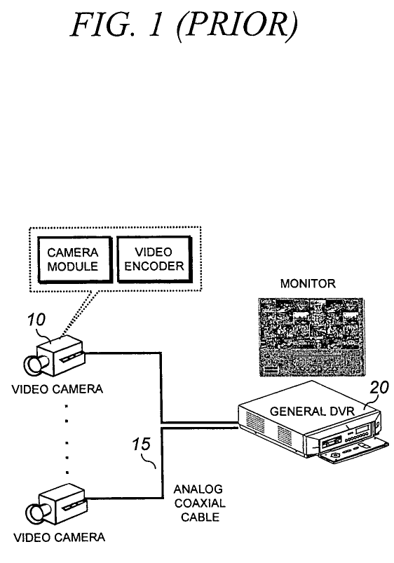

The network DVR 170 receives the bit stream data, which is obtained by dually compressing a single image captured by the network camera. Then, the network digital video recorder 170 decompresses the data compressed by the first moving picture encoder 120 to display it on a monitor in real time (175 and 180) and stores the data compressed by the second moving picture encoder 130 without decompressing it to record the data (176 and 181). The operator of the network DVR 170 can reproduce, transmit or back up the recorded data if required. The network DVR 170 of embodiments of the present invention processes all of the above-described operations through software, distinguished from the DVR shown in FIG. 1. Accordingly, embodiments do not require an additional real-time display board or capture board, which results in simplified system configuration.

Embodiments of the present invention can dually compress an image inputted to the network camera through two moving picture encoders embedded in the network camera. Furthermore, embodiments of the present invention can display the image in real time and record the image through the network DVR. Accordingly, network video cameras can be connected in parallel with a network to save installation space and cost. Moreover, the present invention can simultaneously satisfy the requirements of the DVR for displaying moving pictures in real time with a high picture quality and recording the moving pictures at a low speed with a low picture quality.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. Although the invention has been illustrated and described with respect to exemplary embodiments thereof, it should be understood by those skilled in the art that various other changes, omissions and additions may be made therein and thereto, without departing from the spirit and scope of the present invention. Therefore, the present invention should not be understood as limited to the specific embodiments set forth above but to include all possible embodiments which can be embodied within a scope encompassed and equivalents thereof with respect to the feature set forth in the appended claims.

What is claimed is:

1. A network camera integrated with a camera module, comprising:
a first moving picture encoder for displaying a real-time moving picture; and
a second moving picture encoder for recording, wherein the first and second moving picture encoders compress a digital image captured by the camera module at different picture qualities and rates (the number of frames per second), separately from each other, and transmit the separately compressed images to a network.

2. The network camera as claimed in claim 1, wherein the network camera has two video decoders respectively connected to the first and second moving picture encoders to convert an analog video signal into digital video data with different resolutions such that the first and second moving picture encoders can respectively set resolutions as well as picture qualities and rates, separately from each other.

3. A network camera separated from a camera module, comprising:
a first moving picture encoder for displaying a real-time moving picture; and
a second moving picture encoder for recording,
wherein the network camera converts an analog video signal received from a separate video camera through a cable into digital video data using a video decoder and multiplexes the converted digital video data to respectively apply the multiplexed data to the first and second moving picture encoders, which in turn compress the digital video data at different picture qualities and rates (the number of frames per second), separately from each other, and transmit them to a network.

4. The network camera as claimed in claim 3, wherein the network camera has two video decoders respectively connected to the first and second moving picture encoders to convert an analog video signal into digital video data with different resolutions such that the first and second moving picture encoders can respectively set resolutions as well as picture qualities and rates, separately from each other.

5. A network digital video recorder that receives data, which is obtained by dually compressing an image at different picture qualities and rates, from each of a plurality of network cameras through a network, decompresses data compressed by a first moving picture encoder to display it on a monitor in real time, and stores data compressed by a second moving picture encoder without decompressing it, the network cameras being integrated with a camera module or separated from the camera module.

6. An apparatus configured to:
transmit or receive first compressed video data;
transmit or receive second compressed video data, wherein:
the first compressed video data and the second compressed video data are both compressed from the same source video data;
the first compressed video data and the second compressed video data are compressed at different compression ratios.

7. The apparatus of claim 6, wherein:
the first compressed video data is compressed at a higher compression ratio than the second compressed video data;
the first compressed video data is for recording; and
the second compressed video data is for displaying.

8. The apparatus of claim 6, wherein the apparatus is a camera.

9. The apparatus of claim 8, wherein the camera is a network camera.

10. The apparatus of claim 6, wherein the apparatus is a camera module.

11. The apparatus of claim 10, wherein the camera module is coupled to network.

12. The apparatus of claim 6, wherein the apparatus is a digital video recorder.

13. The apparatus of claim 12, wherein the digital video recorder is a network digital video recorder.

14. The apparatus of claim 6, wherein the first compressed video data and the second compressed video data are transmitted or received over a network.

15. The apparatus of claim 14, wherein the network is an Ethernet network.

16. The apparatus of claim 6, wherein the first compressed video data is compressed at a first encoder and the second compressed video data is compressed at a second encoder.

17. The apparatus of claim 16, wherein at least one of the first encoder and the second encoder are coupled to a camera.

18. The apparatus of claim 17, wherein the camera is an analog camera.

19. The apparatus of claim 16, wherein at least one of the first encoder and the second encoder are coupled to a camera through a decoder.

20. The apparatus of claim 19, wherein the decoder comprises an analog-to-digital converter.

21. The apparatus of claim 16, wherein:
the first encoder is coupled to a camera through a first decoder; and
the second encoder is coupled to the camera through a second decoder.
